(19) United States
(12) Patent Application Publication
(10) Pub. No.: US 2007/0228026 A1
(43) Pub. Date: Oct. 4, 2007

(54) Method for printing laser mark on an inner peripheral surface of a ring

(75) Inventor: Seong-Hoon Kim, Gangnam-Gu (KR)

Correspondence Address: HOLLAND & HART, LLP, P.O BOX 8749, DENVER, CO, 80201, US

(73) Assignee: S. WILL INTERNATIONAL CO., LTD

(21) Appl. No.: 11/415,754

(22) Filed: May 1, 2006

(30) Foreign Application Priority Data
Mar. 31, 2006 (KR) 10-2006-0029415

(51) Int. Cl. B23K 26/08

(52) U.S. Cl. 219/121.82

(57) ABSTRACT

Disclosed is a method for printing a mark on an inner peripheral surface of a ring by using a laser marking apparatus. The laser marking apparatus includes a jig for rotatably supporting the ring, a laser oscillator and a galvano scanner, in which the jig is installed below a laser irradiation port provided in the galvano scanner, grips an outer peripheral surface of the ring such that the ring is inclined at an angle of 5 to 20° with respect to a vertical line, and rotates the ring about a center of the ring as driving force is applied thereto from a stepping motor. The jig is driven such that the jig performs one revolution per 10000 steps of the stepping motor. A plurality of sub-marks having a size of 2 mm are formed by dividing the mark to be printed on the inner peripheral surface of the ring in a transverse direction thereof and the sub-marks are sequentially printed on the inner peripheral surface of the ring through laser irradiation. The jig performs the stepping movement corresponding to each sub-mark having the size of 2 mm.

### BACKGROUND OF THE INVENTION

1. Field of the Invention

The present invention relates to a method for printing a laser mark on an inner peripheral surface of a ring.

2. Description of the Prior Art

A laser mark printing method is performed in manner that a laser beam is irradiated onto a target so that the target is melted, burned, or cut by thermal energy of the laser beam.

In general, laser marking apparatuses are classified into a scan type laser marking apparatus, which directly irradiates the laser beam onto the target so as to print a mark on the target, and a mask type laser marking apparatus, which employs a mask formed with a predetermined pattern as well as a lens for forming an image so as to print a mark on the target. The mask type laser marking apparatus can repeatedly print the same mark pattern on the target at a high speed, but it is difficult for the mask type laser marking apparatus to change the mark pattern.

In the scan type laser marking apparatus, the laser beam generated from a single laser source is irradiated onto a marking target by way of a focus lens, an alignment mirror and a condenser lens. A surface of the marking target locally burns when the laser beam makes contact with the surface of the making target, so that visible marks or characters are formed on the marking target.

In the scan type laser marking apparatus, marking information corresponding to the mark, such as characters, symbols or figures, which is inputted into a console and divided in the transverse direction into a plurality of blocks such that the divided mark has a size suitable for printing by the laser marking apparatus, is previously stored in a memory unit, and a controller reads the marking information corresponding to the mark inputted into the console and creates coordinate data based on the marking information in order to control the on/off operation of the laser source. Thus, the laser beam generated from the laser source is irradiated onto the marking target under the control of the controller, so that the mark inputted into the console is printed on the making target.

However, since the scan type laser marking apparatus irradiates a single laser beam onto the marking target, problems may occur when a marking area is enlarged. That is, if the marking area becomes enlarged, a focal length of a condenser lens is changed, so that the power and quality of the laser beam may be degraded. Such a problem of the laser beam leads to degradation of the marking.

The above problem becomes serious when printing a mark on an annular ring by using the scan type laser marking apparatus. In particular, the problem becomes more serious when printing a mark on an inner peripheral surface of the ring by using the scan type laser marking apparatus.

That is, the ring must be inclined at an angle of 5 to 20° in order to print the mark on the inner peripheral surface of the ring by using the conventional scan type laser marking apparatus, because the conventional scan type laser making apparatus adjusts the focus onto a point in a vertical line and irradiates the laser beam having straightness in the downward direction along the vertical line. However, in this case, focus distance variation may occur at portions of the inner peripheral surface of the ring in the vicinity of the laser focus, so the laser beam cannot be precisely focused when the laser beam is irradiated onto the inner peripheral surface of the ring according to the scan movement of the laser marking apparatus in left, right, upward, and downward directions of the ring, so that the mark is not clearly printed on the inner peripheral surface of the ring.

Therefore, in order to form the mark on the inner peripheral surface of the ring by means of the laser beam generated from the conventional scan type laser marking apparatus, the inner peripheral surface of the ring to be formed with the mark must be shifted corresponding to the laser focus. In this regard, a jig used for supporting the ring must be rotated by a predetermined angle.

### SUMMARY OF THE INVENTION

Accordingly, the present invention has been made to solve the above-mentioned problems occurring in the prior art, and an object of the present invention is to provide a method for clearly printing marks, such as characters, symbols or figures, on an inner peripheral surface of a ring in the circumferential direction of the ring by using a typical laser marking apparatus, which irradiates a laser beam in the downward direction of a vertical line.

In order to accomplish the above object, the present invention provides a method for printing a mark on an inner peripheral surface of a ring by using a laser marking apparatus. The laser marking apparatus includes a jig for rotatably supporting the ring, a laser oscillator and a galvano scanner, in which the jig is installed below a laser irradiation port provided in the galvano scanner, grips an outer peripheral surface of the ring such that the ring is inclined at an angle of 5 to 20° with respect to a vertical line, and rotates the ring about a center of the ring as driving force is applied thereto from a stepping motor. The jig is driven such that the jig performs one revolution per 10000 steps of the stepping motor. A plurality of sub-marks having a size of 2 mm are formed by dividing the mark to be printed on the inner peripheral surface of the ring in a transverse direction thereof and the sub-marks are sequentially printed on the inner peripheral surface of the ring through laser irradiation. The jig performs the stepping movement corresponding to each sub-mark having the size of 2 mm.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a laser marking apparatus; and

FIG. 2 is a view illustrating a mark divided into a plurality of blocks.

### DETAILED DESCRIPTION OF THE PREFERRED EMBODIMENTS

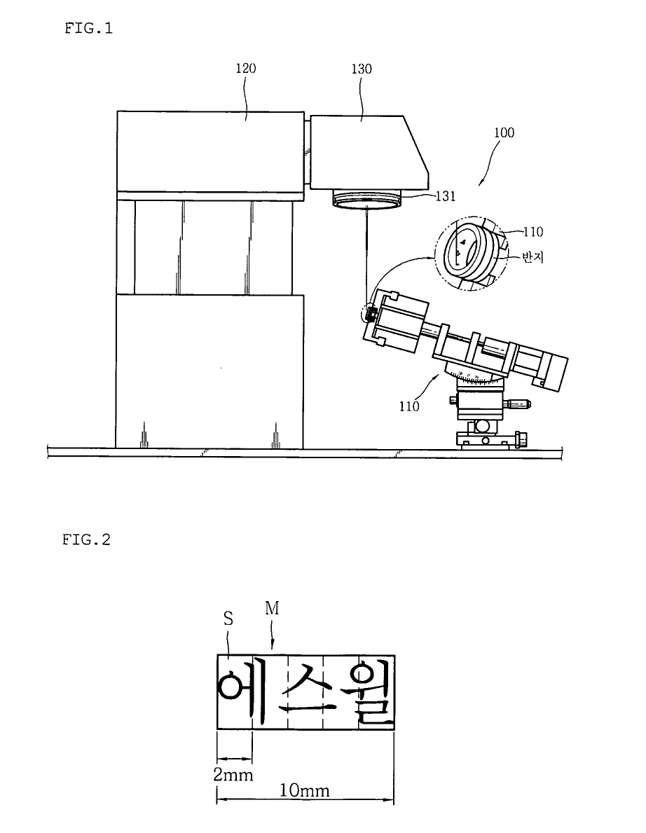

Hereinafter, a preferred embodiment of the present invention will be described with reference to FIG. 1.

FIG. 1 shows a typical laser marking apparatus 100 used for realizing the present invention.

The laser marking apparatus 100 mainly includes a jig 110 for rotatably supporting a ring, a laser oscillator 120 and a galvano scanner 130.

The jig 110 is installed below a laser irradiation port 131 provided in the galvano scanner 130.

The jig 110 grips an outer peripheral surface of the ring such that the ring can be inclined at an angle of 5 to 20° with respect to a vertical line, and rotates the ring about the center of the ring as driving force is applied thereto from a stepping motor (not shown).

The stepping motor used for driving the jig 110 runs 1000 steps for one revolution of the jig 110. If a reduction gear assembly (not shown) having a gear ratio of 1/10 is applied to the stepping motor, the stepping motor may run 10000 steps for one revolution of the jig 110. Such a construction is generally known in the art, so it will not be further described below.

In the laser marking apparatus 100, a mark to be printed on an inner peripheral surface of the ring is inputted into a console (not shown), and the mark displayed in a monitor (not shown) is divided in the transverse direction into a plurality of blocks such that the divided mark has a size of 2 mm, respectively. In this state, a controller sequentially reads marking information corresponding to the divided mark provided in each block, and sequentially creates coordinate data for the divided mark provided in each block with a size of 2 mm based on the marking information in order to control the on/off operation of the laser source. Thus, the laser beam generated from the laser source is sequentially irradiated onto the marking target, thereby printing the mark on the marking target.

At this time, the jig 110 is driven such that it can perform a predetermined number of stepping movements based on following Equation 1, in order to print each divided mark having the size of 2 mm.

$$( ( \frac{360 °}{π * d} ) * 2 ) * \frac{10000}{360 °} = N \qquad Equation 1$$

In Equation 1, d is an inner diameter of the ring, and N is a number of stepping movements of the jig for each divided mark having the size of 2 mm.

Hereinafter, the present invention will be described in more detail.

As shown in FIG. 2, it is assumed that the mark M to be printed on the inner peripheral surface of the ring in the circumferential direction has a size of 10 mm, the ring has an inner diameter of 15.4 mm, and the mark is divided into a plurality of blocks such that the divided mark in each block has a size of 2 mm.

Since the inner diameter (d) of the ring is 15.4 mm, the circumferential length (π*d) of the ring is about 48.38 mm.

In addition, when an angle of 360° corresponding to one revolution is divided by the circumferential length, a value of 7.44°/mm is obtained.

If the above value is multiplied by 2, a value of 14.88°/mm is obtained.

Accordingly, when the above value (14.88°/mm) is applied to the jig, which performs one revolution per 10000 steps of the stepping motor, the jig must run 413.29 steps during the stepping rotation according to following Equation 2.

$$14.88 ° * \frac{10000}{360 °} = number of stepping movements of the jig \qquad Equation 2$$

Such 413.29 steps of the jig may not be easily realized by means of the stepping motor and the reduction gear assembly, so the jig is driven such that it performs 413 steps during stepping rotation.

Accordingly, since the length of the mark to be printed on the inner peripheral surface of the ring in the circumferential direction is 10 mm, the jig sequentially runs 413 steps for each divided mark S having the size of 2 mm, thereby printing the mark on the inner peripheral surface of the ring.

In this manner, if the laser beam is irradiated onto the inner peripheral surface of the ring while the jig is performing the stepping rotation corresponding to the divided mark provided in each block, the mark can be clearly printed on the inner peripheral surface of the ring, even if the laser beam is not precisely focused at the laser irradiation area provided in the inner peripheral surface of the ring.

In this regard, the inventor of the present invention has performed various experiments, and Table 1 shows the experiment results representing the number of steps of the jig for each divided mark having the size of 2 mm, according to the inner diameter of the ring.

TABLE 1

| | | | | Steps of jig |
|---|---|---|---|---|
| Inner diameter | Circumferential | | Angle/ | during stepping |
| (mm) | length (mm) | Angle/1 mm | 2 mm | rotation |
| 15.4 | 48.38 | 7.44 | 14.88 | 413 |
| 15.8 | 49.64 | 7.25 | 14.51 | 402 |
| 16.2 | 50.89 | 7.07 | 14.15 | 392 |
| 16.6 | 52.15 | 6.90 | 13.81 | 383 |
| 17 | 53.41 | 6.74 | 13.48 | 374 |
| 17.4 | 54.66 | 6.59 | 13.17 | 365 |
| 17.8 | 55.92 | 6.44 | 12.88 | 357 |
| 18.2 | 57.18 | 6.30 | 12.59 | 349 |
| 18.6 | 58.43 | 6.16 | 12.32 | 342 |
| 19 | 59.69 | 6.03 | 12.06 | 334 |
| 19.4 | 60.95 | 5.91 | 11.81 | 328 |
| 19.8 | 62.20 | 5.79 | 11.58 | 321 |
| 20.2 | 63.46 | 5.67 | 11.35 | 315 |
| 20.6 | 64.71 | 5.56 | 11.13 | 308 |
| 21 | 65.97 | 5.46 | 10.91 | 303 |
| 21.4 | 67.23 | 5.35 | 10.71 | 297 |
| 21.8 | 68.48 | 5.26 | 10.51 | 291 |
| 22.2 | 69.74 | 5.16 | 10.32 | 286 |
| 22.6 | 71.00 | 5.07 | 10.14 | 281 |
| 23 | 72.25 | 4.98 | 9.96 | 276 |
| 23.4 | 73.51 | 4.90 | 9.79 | 271 |
| 23.8 | 74.77 | 4.81 | 9.63 | 267 |
| 24.2 | 76.02 | 4.74 | 9.47 | 263 |

The present invention employs the jig installed below the laser irradiation port of the laser marking apparatus, which downwardly irradiates the laser beam along the vertical line, wherein the jig performs one revolution per 10000 steps of the stepping motor, so that it is possible to clearly print the mark, such as characters, symbols or figures, on the inner peripheral surface of the ring by dividing the mark into a plurality of blocks having a size of 2 mm in such a manner that the divided marks can be sequentially printed on the ring as the laser beam is irradiated on the inner peripheral surface of the ring.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for printing a mark on an inner peripheral surface of a ring by using a laser marking apparatus including a jig for rotatably supporting the ring, a laser oscillator and a galvano scanner, in which the jig is installed below a laser irradiation port provided in the galvano scanner, grips an outer peripheral surface of the ring such that the ring is inclined at an angle of 5 to 20° with respect to a vertical line, and rotates the ring about a center of the ring as driving force is applied thereto from a stepping motor, the method comprising the steps of:
forming a plurality of sub-marks having a size of 2 mm by dividing the mark to be printed on the inner peripheral surface of the ring in a transverse direction thereof;
determining a number of stepping movements of the jig for each sub-mark having the size of 2 mm according to the following equation:
$$( ( \frac{360 °}{π * d} ) * 2 ) * \frac{10000}{360 °} = N ,$$
wherein d is an inner diameter of the ring, and N is the number of stepping movements of the jig for each sub-mark having the size of 2 mm; and
sequentially printing the sub-marks on the inner peripheral surface of the ring through laser irradiation,
wherein the jig performs one revolution per 10000 steps of the stepping motor.
